(19) United States
(12) Patent Application Publication
(10) Pub. No.: US 2006/0265226 A1
(43) Pub. Date: Nov. 23, 2006

(54) Lerning shoes

(76) Inventors: Hoang Van Nguyen, San Jose, CA (US); Ngoc Anh Mai, San Jose, CA (US)

Correspondence Address: HOANG VAN NGUYEN, 277 STAPLES AVE., SAN JOSE, CA, 95127, US

(21) Appl. No.: 11/136,225

(22) Filed: May 23, 2005

(51) Int. Cl. G10L 21/00

(52) U.S. Cl. 704/275

(57) ABSTRACT

A learning shoe consists of a voice chip circuit, motion trigger, battery, and speaker is an assembly, which is attached to a shoe. The circuit activates, via the motion trigger, with each child's step to deliver a pre-programmed audible phrase to the speaker. The voice chip can consist of multiple phrases, each phrase triggered in sequence with each triggering of the circuit. The audible phrases are triggered in a closed loop cycle enabling the phrases to repeat over and over. Audible phrases responding to each child's step may be like: A, B, C . . . or one, two, three . . . or phrases in alternate languages. The learning shoe assembly is mounted on the shoe. An optional switch may also be implemented into the circuit to turn on or off power.

### BACKGROUND OF THE ENVENTION

This invention relates to children's shoes into which the voice circuit is incorporated. Wherein children can learn and repeat multiple sounds during walking.

Several types of footwear having a sound system are known in the art. U.S. Pat. No. 2,612,135 discloses a tinkle bell carried by a shoelace. U.S. Pat. No. 4,646,350 discloses a microcircuit in the fold of a shoe trap, which activates an audible message when the trap is fastened or loosened. U.S. Pat. No. 2,320,560 discloses a toy compressing right and left elements which a child may removable attach to his shoes and which will produce an amusing sound with each step the child takes in ordinary walking. Neither of these systems are designed language phrases to help a child learn to speak during walking.

### SUMMARY OF THE INVENTION

Accordingly, it is an additional objective of this invention to provide children's shoes having a sound system built therein.

At every child's step the motion trigger activate the voice chip to produce a sound or phrase like A or B or C . . . or one or two . . . or Papa or Mama . . . or blue or green . . . etc. The voice chip is programmed to produce the different phrases in sequence, once phrase for each child's step. After the voice chip finished all pre-programmed phrases, the voice chip will cycle to back the first phrase again and repeat in a closed loop. For example, the voice chip may be programmed with the 26 letters of the alphabet. The first child's step on this shoe will produce the sound A. The second step will produce the sound B. This will continue in sequence until the twenty sixth step on this shoe, which produces the sound Z. The twenty seventh step on this shoe starts with new cycle with the sound A again.

The voice chip is programmed to reset to the initial pre-recorded phrase when the power is reset or after a pre-determined timeout period when the shoe is not used.

The left shoe and right shoe have the same sound system thus when the child is walking the sound will repeated on left and right shoes. For example, if the voice chip is programmed with alphabet, when the child's walking the sound A, A and B, B . . . etc. will be heard. The two voice circuits are not synchronous, however, thus two steps on one shoe will cause the phrases to be different with each subsequent steps.

Depending on the design of the shoes the speaker can be mounted on front, back or side of the shoe to have the best sound quality.

### BRIEF DESCRIPTION OF THE DRAWINGS

The “learning shoe” invention will become more fully understood from the detailed description given herein below:

FIG. 1 is a block diagram of a preferred embodiment of sound system of the present invention.

FIG. 2 shows side view of learning shoe with the speaker and switch, which are mounted on the side of the shoe.

FIG. 3 shows a perspective view of the learning shoe with the speaker and switch, which are mounted on the back of shoe.

FIG. 4 is an explore view of the learning shoe shown in FIG. 3.

### DETAILED DESCRIPTION OF THE INVENTION

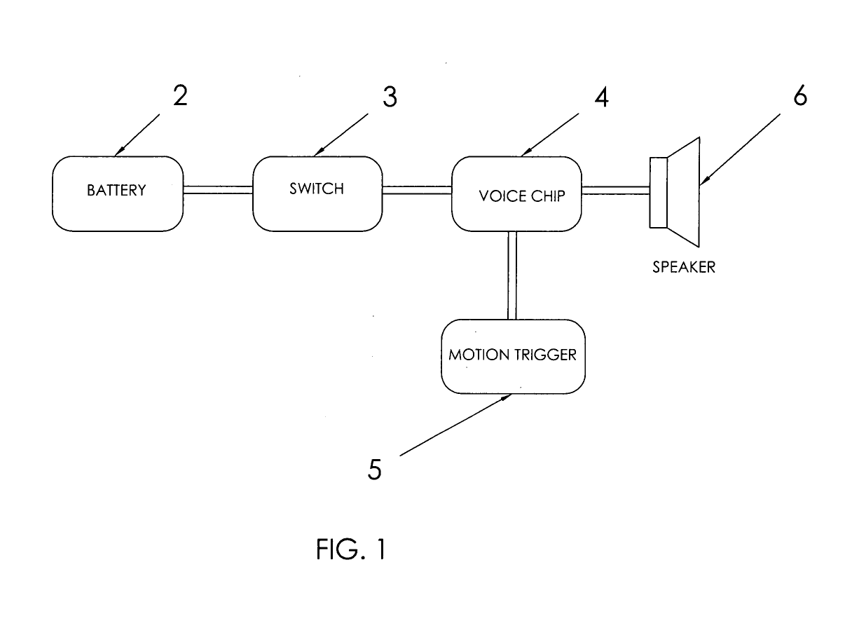

Referring first to FIG. 1, the invention comprises of several basis components including a power source 2, a switch 3, a voice chip circuit 4, a motion trigger 5, and a speaker 6.

The power source 2 could be one or more batteries to power the sound system. The power source is connected to switch 3 to turn system on or off. The switch 3 could be a touch, push-button, rotary, or slide switch. The voice chip circuit 4 is connected to the switch 3 and speaker 6. The voice chip circuit consists of any circuitry capable of producing a sound in response to a trigger signal from motion trigger 5 may be implemented for this invention. The motion trigger 5 is connected to voice chip circuit 4. At every motion the trigger activates the voice chip to produces a sound. Any type of motion triggers may been used to create this effect, for example, pressure, spring, or mercury switches. The speaker 6 could be programmed for a defined volume or have a separate volume adjustment.

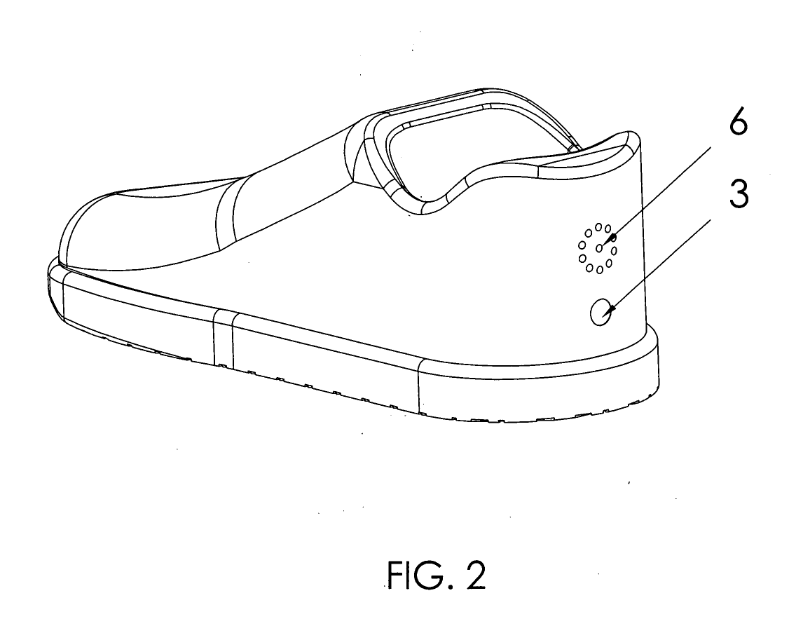

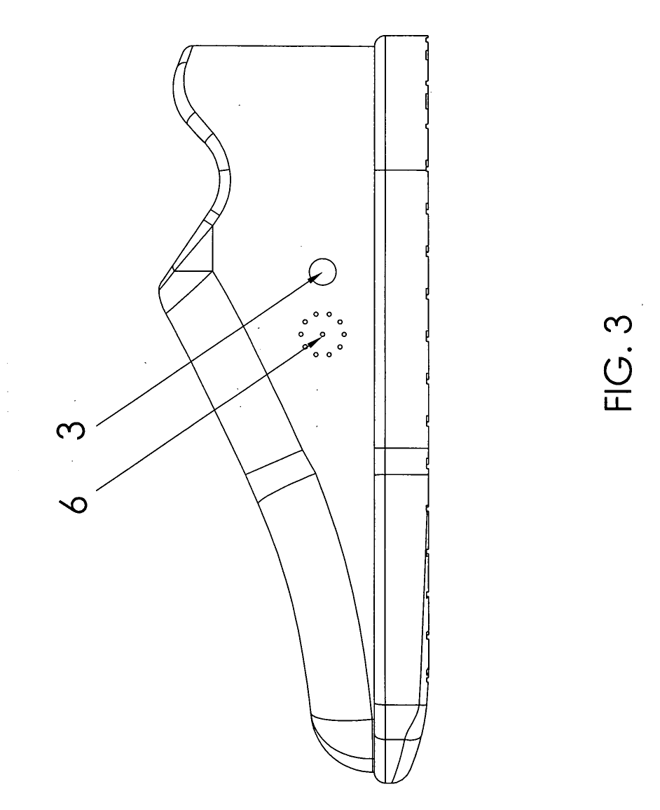

Referring next to FIG. 2, the sound system is mounted on the side of the footwear. For different designs of footwear, the sound system could be attached on the back of the footwear like on FIG. 3 or on the front or anywhere else desired on the footwear in order to not interfere with normal activity.

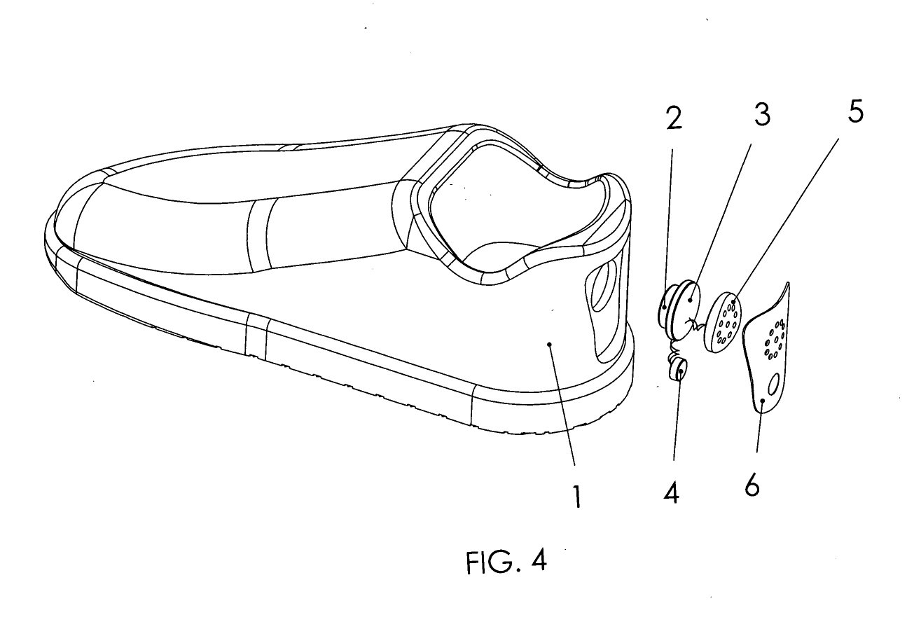

FIG. 4 is a perspective view of the learning shoe shown in FIG. 3 but with portions of shoe removed for the purpose of illustrating the manner of all components of the present invention.

The footwear may be produced in different designs, sizes, materials, and in other forms of footwear such as loafers, slippers, and moccasins.

What we claim as our invention is:

1. A sound system to be incorporated into footwear, comprising:
a power source for energizing the sound system.
a voice chip circuit connected with the power source.
a speaker contained within said footwear; wherein said speaker is coupled to said voice chip circuit and converts each sound signal into an audible sound.
a motion trigger means connected with said voice chip circuit, said motion trigger means providing a contact signal to voice chip circuit, at each child's step said voice chip circuit providing each simple sound.

2. A sound system according to claim 1, further comprising a switch to turn on and off sound system.

3. A sound system according to claim 1, wherein said voice chip circuit providing different sounds for every child's step, these sounds be repeated after finish a cycle of sound.

4. A sound system according to claim 1, wherein said voice chip circuit automatically resetting to the initial pre-recorded phrase when the power is reset or after a pre-determined timeout period when the shoe is not used.

5. A sound system according to claim 1 wherein said voice chip circuit is voice record able.
